(19) United States
(12) Patent Application Publication
(10) Pub. No.: US 2009/0180271 A1
(43) Pub. Date: Jul. 16, 2009

(54) Nightlight Flashlight

(76) Inventor: Emil F. Jachmann, West Springfield, MA (US)

Correspondence Address: MCHALE & SLAVIN, P.A., 2855 PGA BLVD, PALM BEACH GARDENS, FL, 33410, US

(21) Appl. No.: 12/013,942

(22) Filed: Jan. 14, 2008

(51) Int. Cl. F21V 19/04; F21L 4/00; H05B 41/36

(52) U.S. Cl. 362/20; 362/183; 315/291

(57) ABSTRACT

An emergency light system that includes a housing that is easily mounted in a conventional power outlet box. The system includes a night light within the housing that is automatically actuated by a low level of ambient light. The automatic activation can be disabled by a manual switch. In the event of a power failure the night light can be automatically illuminated by a rechargeable battery power supply. The housing also serves as a support and source of electricity for a portable, handheld, rechargeable flashlight. The lighting system provides clear system indicators to help maintain the system in an easy to access and easy to maintain operational condition. The housing also includes a pass through AC outlet to act as a source of electricity for an additional electrical appliance.

### FIELD OF THE INVENTION

The present invention relates to an emergency lighting system and more particularly, to an improved flashlight with a night light base.

### BACKGROUND OF THE INVENTION

The present invention relates to a combination flashlight and night light, and particularly, to a flashlight that is rechargeable within a wall mounted base. The wall mounted based further includes a housing for a night light which can also function as an emergency light in the event of a power failure.

Homes, offices, commercial and industrial facilities frequently experience situations where the electrical utility company has undergone an unexpected interruption of service. These power failures may be caused by natural disasters (i.e. floods, hurricanes, tornados, snow or ice storms) or caused by brown outs, fire, accidents or acts of terrorism. Most of these facilities do not have emergency back up generators, particularly residential homes, and only have hand held light sources, such as flashlights. Some establishments have emergency lighting devices that are connected to an emergency power supply to energize the emergency lighting upon detection of a power failure. These emergency lighting devices include a rechargeable energy source and may include a night lighting feature. Typical emergency light fixtures require customized design to accommodate the location in which they are installed and involve a complex installation process and in most retrofit installations require additional wiring and alteration of the existing walls.

Therefore, a need exists to provide an emergency lighting system that is simple and easy to install that includes a night light and rechargeable emergency power failure light, in combination with a hand held rechargeable flashlight and recharging receptacle.

### DESCRIPTION OF THE PRIOR ART

The present invention is directed to an emergency lighting system including a wall mounted base that contains a night light and self recharging emergency light as well as a bracket for receiving a rechargeable flashlight.

U.S. Pat. No. 6,045,232, to Buckmaster, is directed to an apparatus for providing emergency and night lighting which is able to detect the occurrence of a power failure and provide emergency lighting.

U.S. Pat. No. 5,473,517, to Blackman, is directed to an emergency light source which is electrically connectable to a conventional light switch. The housing replaces a conventional switch plate and has at least one opening to a receiving the switch actuator for the light switch. The emergency light source includes rechargeable batteries.

U.S. Pat. No. 4,611,264, to Bradley, is directed to a combination rechargeable flashlight and light switch mounting.

U.S. Patent application publication 2007/0153494, to Huang, is directed to a portable and rechargeable emergency light source which is mounted in a housing.

U.S. Pat. No. 5,692,825, to Shalvi, is directed to a rechargeable flashlight that is recharged via a plug that is inserted into a standard wall socket. The plug is retractable into the flashlight. A night light is also incorporated into the body of the rechargeable flashlight.

U.S. Patent application publication 2004/0090774, to Hsueh, is directed to a portable plug in rechargeable light source that can function as a flashlight, a night light or an emergency light in the event of a power interruption.

U.S. Pat. No. 5,645,342, to Liao, is directed to a wall mounted lamp which is configured to receive a rechargeable flashlight.

U.S. Pat. No. 4,590,543, to Chen, is directed is directed to a portable rechargeable light source that can function as a flashlight, a night light, or an emergency light in the event of a power interruption. The light source is held and recharged in a wall holder and is electrically connected to a plug in type rectifier.

U.S. Pat. No. 6,709,126, to Leen, is directed to a plug in type night light.

U.S. Pat. No. 4,414,611, to Seltzer et al, is directed to a light source that can be powered by an internal battery or an external power source.

U.S. Pat. No. 4,631,649, to McCue et al; is directed to an emergency light fixture that is permanently mounted in a conventional power outlet box. The emergency light fixture includes a housing, an electric plug extending from the rear wall of the housing, a battery, a battery charger, and a lamp mounted in the housing and wired to provide illumination during a power outage. The fixture also includes an aperture in the rear wall of the housing for accommodating a screw for permanently attaching the housing to the outlet box. The aperture is in a fixed relationship with the electric plug so that the aperture is aligned with the threaded bore in the outlet box when the electric plug is aligned with the slots in the outlet box.

These prior art patents disclose various constructions for emergency lighting systems. It would be highly desirable to utilize the disclosed combination rechargeable flashlight, night light, and power failure light. The invention includes an easily installed wall mounted base that serves as the housing for the night light and emergency light as well as a bracket for supporting the flashlight in its recharging position. The base also includes a pass through AC outlet for connection to an additional electrical appliance.

### SUMMARY OF THE INVENTION

Discloses is an emergency lighting system comprising a having an electrical male plug member on a back wall of the housing that is configured to be plugged into a conventional electrical wall outlet; said plug member providing a first source of electricity to said housing and being capable of holding said housing flush against a wall upon which the electrical wall outlet is mounted. A night light is mounted in said housing together with a rechargeable power supply mounted in said housing. The night light being powered by the first source of electricity or said rechargeable power supply in the event of a power failure from the first source of electricity. A rechargeable portable hand held flashlight wherein said housing includes a flashlight light bracket and a flashlight holder for holding the rechargeable flashlight; said housing further including charging contacts configured to connect with contact poles on the flashlight whereby electricity from said first source of electricity is capable of recharging said flashlight.

It is an object of this invention to provide an affordable, multifunction, emergency lighting system. More specifically, the invention is a compact, easy to install and easy to use emergency lighting system.

Accordingly, it is a primary objective of the instant invention to provide an emergency lighting system that includes a night light, an emergency power failure light and a hand held rechargeable flashlight.

It is a further objective of the instant invention to provide an emergency lighting system that is both easy to install and easy to use.

It is yet another objective of the instant invention to provide an emergency lighting system that is compact in design and aesthetically pleasing.

It is a still further objective of the invention to provide an emergency lighting system that provides clear system indicators to help maintain the system in an easy to access and easy to maintain operational condition.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is an illustration of the rechargeable LED flashlight positioned in a flashlight charging holder located within the night light base.

FIG. 2 is a front view of the night light base.

FIG. 2A is a side view of the night light base.

FIG. 3 is a partial sectional view of the rechargeable flashlight.

FIG. 4 is a top view of the rechargeable flashlight.

FIG. 5 is an electrical diagram for the night light base.

FIG. 6 is an electrical diagram for the rechargeable flashlight.

### DETAILED DESCRIPTION OF THE INVENTION

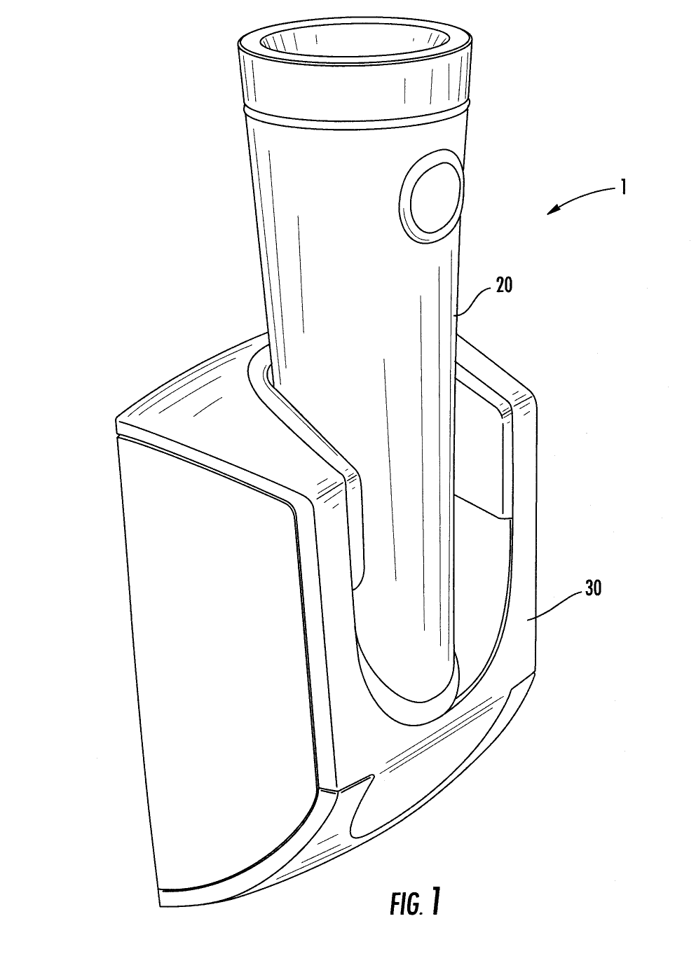

Referring first to FIG. 1 the emergency lighting system 1 includes a rechargeable flashlight 20 and a wall mounted night light base 30.

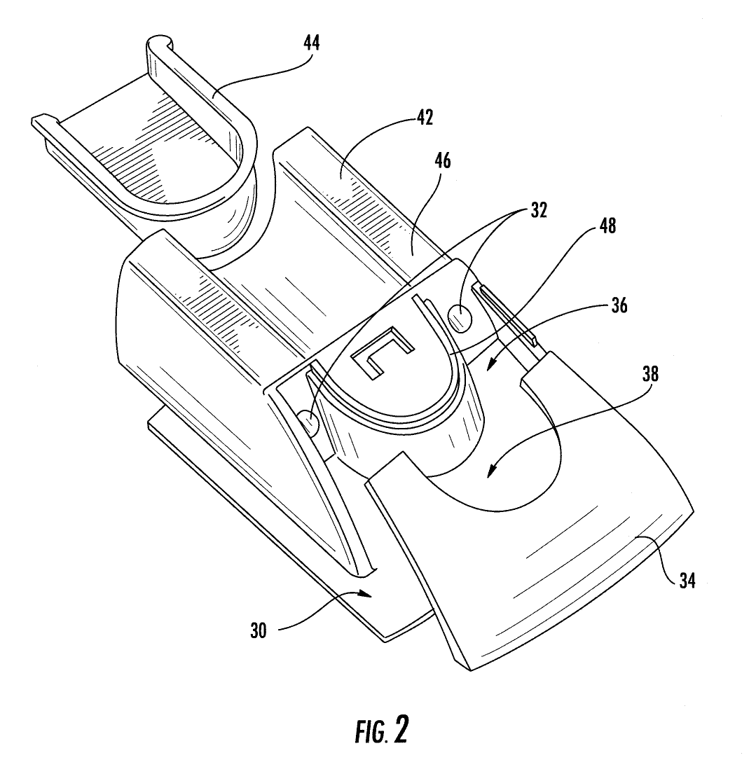

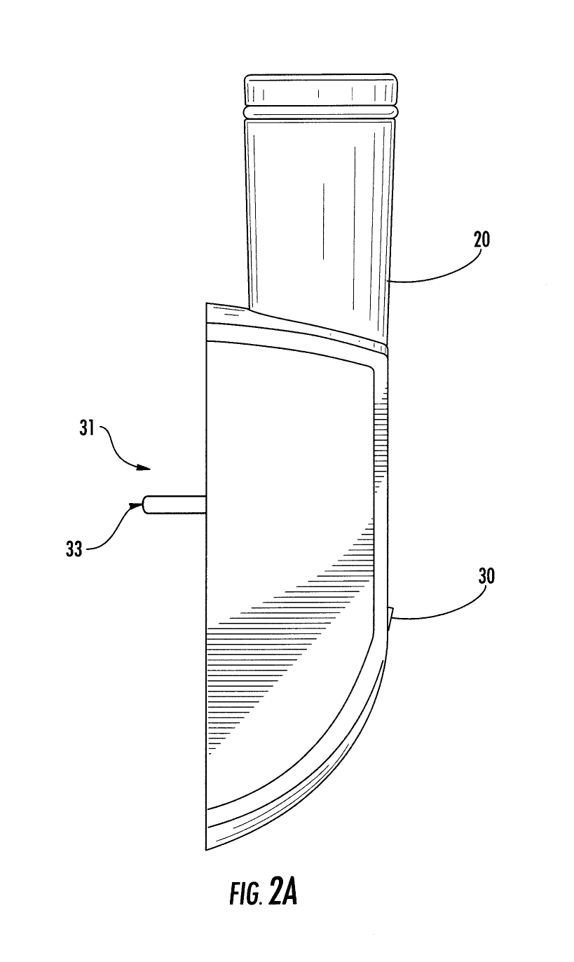

FIG. 2 is an illustration of the night light base 30 with some pieces partially removed for clarity and for the purpose of explanation. Night light base 30 contains two LEDs 32. The night lights produce a warm color preferably a yellow/orange (or amber) color. The night light brightness is approximately equivalent to a 5W AC bulb (20-40 lumens) which is typical for a night light. A removable night light cover 34 (shown partially removed from the night light base 30 in FIG. 2) covers the LEDs 32. Also mounted on the night light base 30 and under the translucent cover 34 is a manually operated two position switch 36 to control the operation of the LEDs. Switch 36 can to be moved to either an auto on or night light off position.

The night light wall base unit is designed to be wall mounted to a conventional electrical wall outlet. As shown in FIG. 2A base unit 30 is provided with a male plug affixed to the back of the night light base. The plug has two blades 3land one ground pin 33. The night light base 30 is plugged in to a conventional wall outlet. The design of the night light base is such that the base will stay flush to the wall when loaded with the rechargeable flashlight. Therefore, the night light base and rechargeable flashlight can be held in place by only the blades and ground pin. For added security and safety, a screw hole 38 is formed in the night light base and is configured to receive a screw. The screw is designed to secure the night light base to the central screw in the outlet wall plate. The screw is positioned on the night light base under removable translucent cover 34.

Night light base 30 also includes a flashlight bracket 42 and a flashlight holder 44. Bracket 42 and holder 44 are translucent and allow light from night light LEDs 32 to illuminate the flashlight holder. This feature is both attractive and functional. In the event of a power failure the illuminated bracket will help facilitate the user's ability to locate and retrieve the flashlight from the flashlight holder.

Night light base 30 also includes a pass through AC outlet 48 to act as a source of electricity for an additional electrical appliance.

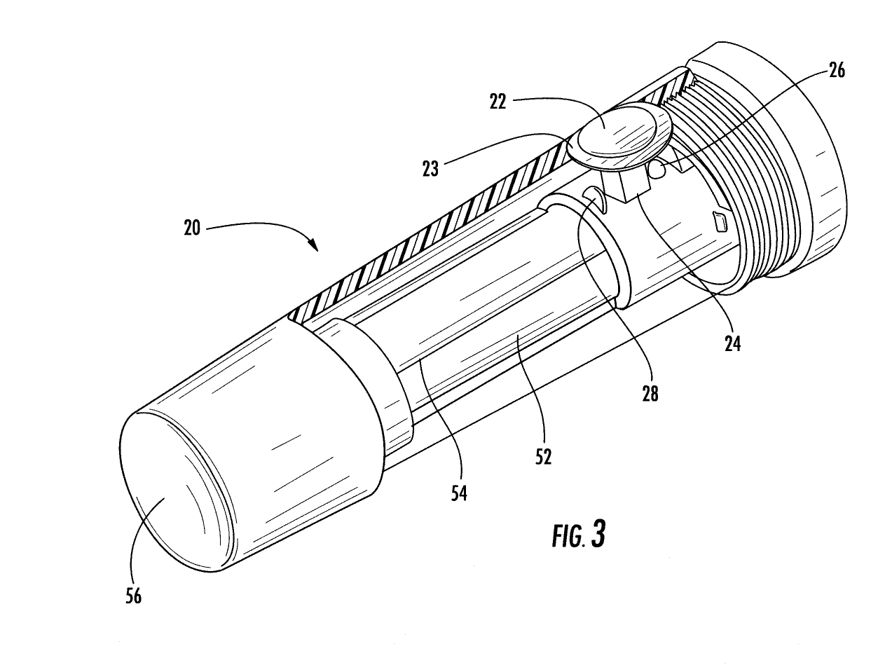

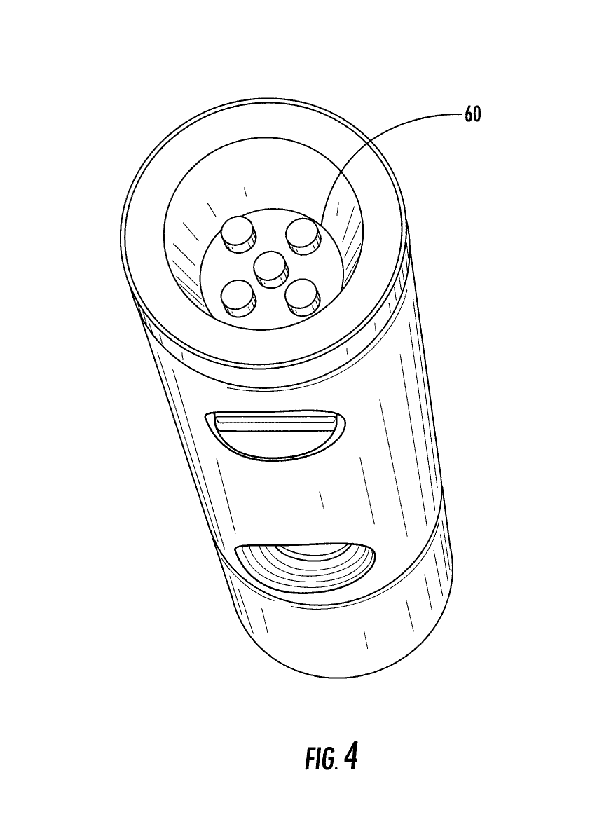

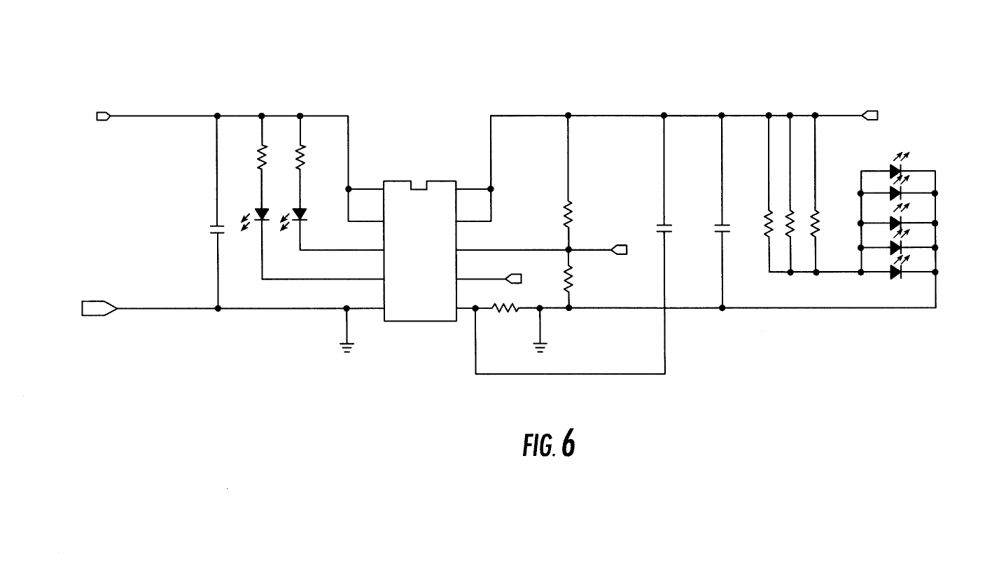

FIG. 3 is a partial sectional view of rechargeable flashlight 20. Rechargeable flashlight 20 includes a push button 22 for on/off switch 24. Surrounding push button 22 is a translucent annular ring 23 which is designed to indicate the charging status of the flashlight 20 via selective illumination of LEDs 26 and 28. LED 28 illuminates when the flashlight is recharging and LED 26 also lights indicating the flashlight is fully charged. Flashlight 20 may also include a reflector and lens (not shown) to shape, focus and or intensify the light beam. Flashlight 20 may have from 3 to 5 LEDs 60 (as shown in FIG. 4) as its source of illumination. Flashlight 20 also includes rechargeable batteries 52 (preferably 3 AAA batteries) within a battery cassette 54. Located at the tail end of flashlight 20 are contact poles 56 for recharging the flashlight that are designed to mate with charging contacts on the night light base. The flashlight may also include an auxiliary charging connector to enable the flashlight to be charged by an external power supply such as a USB connector. The flashlight also contains its own recharging circuitry, as is shown in FIG. 6.

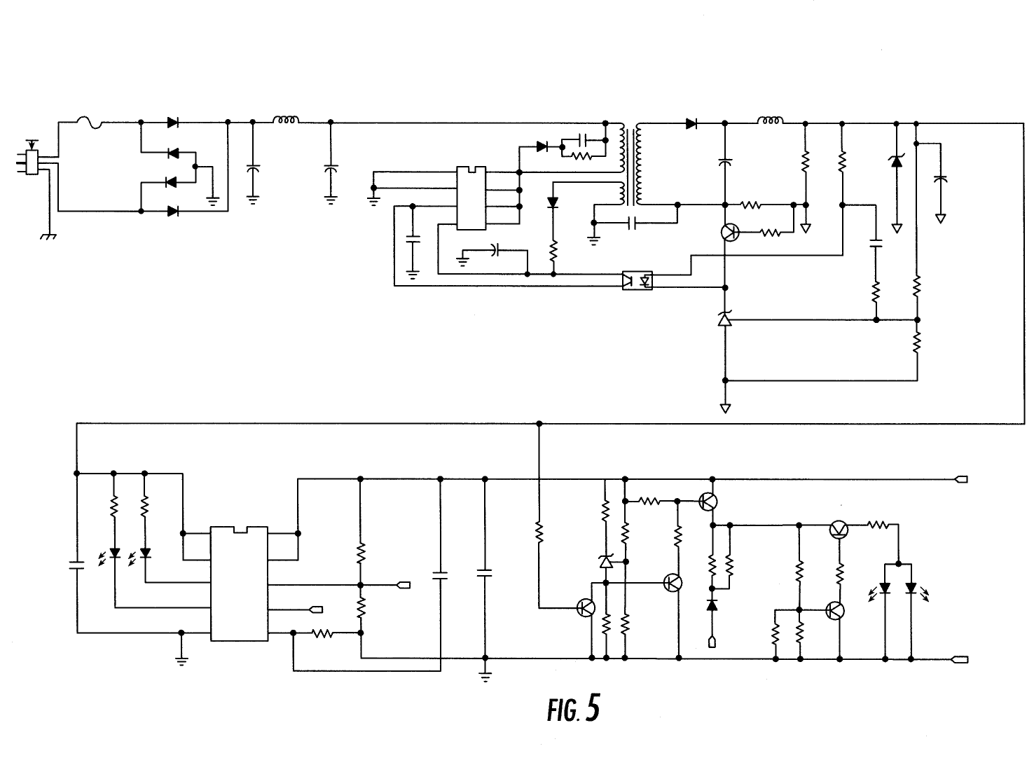

The night light provides a warm color light, preferably a yellow/orange (or amber). The night light has an electronic photo sensor 46 to detect ambient light. The photo sensor will disable the night light when the ambient room light exceeds the light provided by night lights by a predetermined amount. The electronic photo sensor 46 will enable the night light when the ambient light drops below a predetermined amount and have a suitable switching range to avoid flickering on and off in gradually changing ambient light situations such as day truing to night in the evening and night turning to day in the morning. The night light has a power failure battery back up to operate the night light LEDs 32. The night light charger (as shown in the electrical diagram of FIG. 5) will charge the night light batteries safely without overcharging. The night light batteries can be charged in a matter of hours with AC power present.

As noted above, a two position switch 36 is located under translucent cover 34 that is removable by the user. The two position switch has an auto (on/off) and an off position. In the auto position the night light LEDs 32 will operate when the electronic photo sensor 46 detects low ambient light. In the off position it will keep the night light LEDs off. In the event of a power failure, the loss of power will be electronically detected and the LEDs 32 will illuminate in a power failure if the switch 36 is in the on position and the photo sensor detects low ambient light conditions and the rechargeable night light batteries have sufficient power. When fully charged, the night light rechargeable batteries can provide up to 8 hours of run time for LEDs 32 at the specified output level in the event of a power failure.

Flashlight 20 has long life rechargeable batteries 52 contained within the flashlight housing. The rechargeable batteries are capable of up to five hundred charge and discharge cycles. When the flashlight 20 is charging the bottom half of ring 24 will be illuminated by LED 28 which will produce an orange glow on the bottom half of the annular ring 24. When the flashlight 20 is fully charged the entire ring 23 around push button 22 will glow orange in response to the light produced by both LEDs 28 and 26. The switch 24 will have two operational modes. The first press of the on/off button 22 will turn on in low brightness low current mode and be capable of operation for a predetermined time. The second press of the on/off button 22 will raise the brightness to a maximum, high current mode and will be capable of operation for a reduced predetermined time. A third press of the on/off button will result in tuning off power to all the LEDs 60.

FIGS. 5 and 6 are electrical diagrams of the night light base and the rechargeable flashlight, respectively.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An emergency lighting system comprising:
a housing, said housing is provided with an electrical male plug member on a back wall of the housing that is configured to be plugged into a conventional electrical wall outlet;
said plug member providing a first source of electricity to said housing;
said electrical plug being capable of holding said housing flush against a wall upon which the electrical wall outlet is mounted;
a night light mounted in said housing,
a rechargeable power supply mounted in said housing,
said night light being powered by the first source of electricity or said rechargeable power supply in the event of a power failure from the first source of electricity;
a rechargeable portable hand held flashlight;
said housing further including a flashlight light bracket and a flashlight holder for holding the rechargeable flashlight;
said housing further including charging contacts configured to connect with contact poles on the flashlight whereby electricity from said first source of electricity is capable of recharging said flashlight.

2. The emergency lighting system of claim 1 wherein the night light is comprised of a plurality of LEDs.

3. The emergency lighting system of claim 2 wherein the night light LEDs produce an amber color.

4. The emergency lighting system of claim 1, further including an electronic photo sensor electrically connected to the night light that will disable the night light when ambient room light exceeds the light provided by the night lights by a predetermined amount and will enable the night light when the ambient light drops below a predetermined amount.

5. The emergency lighting system of claim 4 wherein the night light is connected to a two position switch and when said switch is in a first position the electronic photo sensor will control the operation of the night light and when in the second position the night light will remain off regardless of the ambient light sensed by the electronic photo sensor.

6. The emergency lighting system of claim 1 wherein the housing includes a screw hole configured to receive a mounting screw that will secure the housing to a central screw hole in the conventional electrical wall outlet.

7. The emergency lighting system of claim 1 wherein a removable translucent cover is attached to the night light housing and covers the night lights.

8. The emergency lighting system of claim 5 wherein a removable translucent cover is attached to the night light housing and covers said two position switch.

9. The emergency lighting system of claim 6 wherein a removable translucent cover is attached to the night light housing and covers said mounting screw.

10. The emergency lighting system of claim 1 wherein the night light housing includes a pass through AC outlet connected to the first source of electricity to provide power for an additional electrical appliance.

11. The emergency lighting system of claim 1 wherein the flashlight holder and bracket are translucent and transmit light produced by the night light.

12. The emergency lighting system of claim 1 wherein the light source for the hand held rechargeable flashlight is comprised of a plurality of LEDs and includes rechargeable batteries as the flashlight power source.

13. The emergency lighting system of claim 12 wherein the hand held rechargeable flashlight includes a push button to activate a multi operational switch.

14. The emergency lighting system of claim 12 where the hand held rechargeable flashlight includes a push button actuator, and further includes a translucent annular ring surrounding said push button which is designed to indicate the charging status of rechargeable flashlight batteries via the selective illumination of either one or two indicator LEDs positioned under the annular ring at the top and bottom thereof, whereby when the batteries are charging only the bottom indicator LED is illuminated thereby illuminating the bottom half of the ring and when the rechargeable flashlight batteries are fully charged both the bottom and top indicator LEDs are illuminated thereby illuminating the entire annular ring.

15. The emergency lighting system of claim 13 wherein a first press of the push button actuator will cause the multi operational switch to turn on the light source of the rechargeable flashlight to a low brightness low current mode and be capable of operation for a predetermined time, and, a second press of the push button actuator will cause multi operational switch to raise the brightness to a maximum high current mode and will be capable of operation for a reduced predetermined time, and, a third press of the push button actuator will cause the multi operational switch to turn off the power to the light source of the rechargeable flashlight and the cycle of operation will repeat thereafter.

16. A hand held rechargeable flashlight comprising;
a light source for said hand held rechargeable flashlight wherein said light source is comprised of a plurality of LEDs;
said rechargeable flashlight further including rechargeable batteries as the power source for the flashlight that are recharged via connection to an external power source;
said rechargeable flashlight also includes a push button actuator, and further includes a translucent annular ring surrounding said push button which is designed to indicate the charging status of rechargeable flashlight batteries via the selective illumination of either one or two indicator LEDs positioned under the annular ring at the top and bottom thereof,
whereby when the batteries are charging only the bottom indicator LED is illuminated thereby illuminating the bottom half of the ring and when the rechargeable flashlight batteries are fully charged both the bottom and top indicator LEDs are illuminated thereby illuminating the entire annular ring.

17. The hand held rechargeable flashlight of claim 16 wherein a first press of the push button actuator will cause a multi operational switch to turn on the light source of the rechargeable flashlight to a low brightness low current mode and be capable of operation for a predetermined time, and, a second press of the push button actuator will cause the multi operational switch will to raise the brightness to a maximum high current mode and will be capable of operation for a reduced predetermined time, and, a third press of the push button actuator will cause the multi operational switch to turn off the power to the light source of the rechargeable flashlight and the cycle of operation will be repeated thereafter.

18. The hand held rechargeable flashlight of claim 17, wherein the light source for the rechargeable flashlight includes three to five LEDs.
